(19) United States
(12) Patent Application Publication
(10) Pub. No.: US 2004/0143517 A1
(43) Pub. Date: Jul. 22, 2004

(54) System and method for managing material distribution and returned materials

(76) Inventor: Ming Fang Tsai, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/748,314

(22) Filed: Dec. 29, 2003

(30) Foreign Application Priority Data
Dec. 27, 2002 (TW) 91137606

(51) Int. Cl. G06F 17/00

(52) U.S. Cl. 705/28; 707/104.1

(57) ABSTRACT

A system for managing material distribution and returned materials includes a database (100) for storing relevant data used or generated in implementing the system, and an application server (120) for managing material distribution and returned materials by executing an inventory management program (150). The inventory management program includes a material distribution management module (1502) for managing outgoing stocks that are to be distributed to different places, and a returned material management module (1503) for managing incoming stocks received from different places. A method for managing material distribution includes the steps of: transmitting material extraction information to an application server; generating inventory variation information; receiving checked inventory variation information; and updating corresponding data records stored in a database. A method for managing returned materials includes the steps of: transmitting information on incoming stocks; generating inventory variation information; receiving checked inventory variation information; and updating corresponding data records stored in a database.

### BACKGROUND OF THE INVENTION

1. Field of the Invention

The present invention relates to material inventory management systems and methods, and especially to a system and method for managing inventory of returned materials and of materials that are to be distributed to production departments of an enterprise.

2. Background of the Invention

Manufacturing operations generally require purchasing and maintaining an inventory of material for fabricating products. Efficient use of the inventory material can reduce costs associated with fabricating the products. One example of a material management system for efficiently using inventory material utilizes visual product representations stored in a computer memory. An operator of the system may select one or more of the product representations to be displayed on a computer screen. Then the operator may interactively arrange the product representations into an acceptable layout. The operator may also fabricate a nest for a particular size of material, order to optimize use of the material. The fabricated nest is then stored in the computer, and used in fabricating the products from the material.

Additionally, computer systems are generally used in material management systems for tracking the inventory material throughout its corresponding manufacturing operations. This enables additional material to be purchased and received so that manufacturing and delivery schedules are adhered to. For example, various types and sizes of materials may be required to support manufacturing various products. The computer systems are generally used for determining that particular material has been removed from inventory to support the fabrication of one or more products, and for determining that particular material remaining in inventory is sufficient to support future fabrication requirements.

However, there is no material management system that provides means for recording inventory variations in detail. When materials are distributed to production departments for fabricating products, or are returned by customers for reasons such as unsatisfactory quality, inventory records of these materials need to be changed. Managing those materials efficiently can improve the efficiency of inventory control. Therefore what is needed is a material inventory management system and method for managing material distribution and returned materials, and for recording inventory variations precisely and in a timely manner.

### SUMMARY OF THE INVENTION

A main objective of the present invention is to provide a system and method for managing material distribution and returned materials, in which material distribution operations and returned materials can be managed conveniently, and in which inventory variations can be recorded in detail.

To achieve the above objective, a system for managing material distribution and returned materials in accordance with the present invention comprises a database for storing relevant data used or generated in implementing the system, and an application server for managing material distribution and returned materials by executing an inventory management program. The application server comprises a basic data management module for maintaining information including material types, storage locations, and production departments; a material distribution management module for managing outgoing stocks that are to be distributed to different places; a returned material management module for managing incoming stocks that are received from different places; a manufacturing order management module for maintaining manufacturing orders; and a database connection module for connecting the basic data management module, the material distribution management module, the returned material management module and the manufacturing order management module with the database.

In addition, the present invention provides a method for managing material distribution. The method comprises the steps of: transmitting material extraction information to an application server; generating inventory variation information; receiving checked inventory variation information; and updating corresponding data records stored in a database.

Furthermore, the present invention provides a method for managing returned materials. The method comprises the steps of: transmitting information on incoming stocks to be received by a warehouse to an application server; generating inventory variation information; receiving checked inventory variation information; and updating corresponding data records stored in a database.

Other objects, advantages and novel features of the present invention will be drawn from the following detailed description of a preferred embodiment and preferred methods of the present invention with the attached drawings, in which:

### BRIEF DESCRIPTION OF THE DRAWINGS

FIG. 1 is a schematic diagram of hardware configuration of a system for managing material distribution and returned materials in accordance with the preferred embodiment of the present invention;

FIG. 2 is a schematic diagram of main software modules of an inventory management program executed by an application server of FIG. 1, and of main data records stored in a database of FIG. 1;

FIG. 3 is a flowchart of a preferred method for managing material distribution in accordance with the present invention; and

FIG. 4 is a flowchart of a preferred method for managing returned materials in accordance with the present invention.

### DETAILED DESCRIPTION OF THE INVENTION

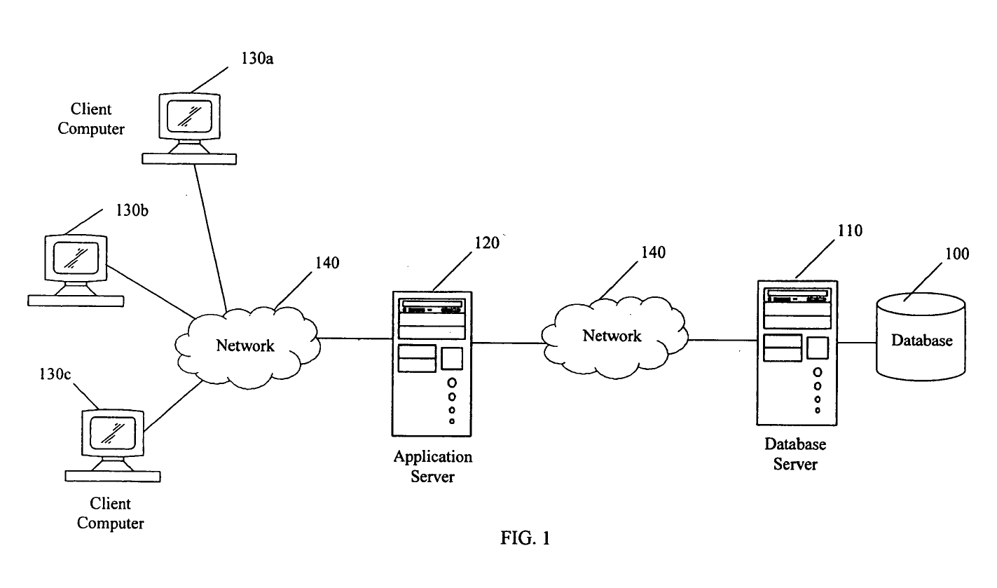

FIG. 1 is a schematic diagram of hardware configuration of a system for managing material distribution and returned materials in accordance with the preferred embodiment of the present invention. The system utilizes a three-layer architecture comprising a data access layer, a logic layer, and a presentation layer. The data access layer comprises a database 100 and a database server 110. The logic layer comprises an application server 120. The presentation layer comprises a plurality of client computers. For the purposes of conveniently illustrating the preferred embodiment of the present invention, three client computers 130a, 130b, 130c are shown and described hereinafter. A communications network 140 interconnects all the above-mentioned entities in order to realize cooperative functioning between those entities.

The database 100 stores relevant data used or generated in implementing the system. Such relevant data comprise material distribution records, returned material records, manufacturing orders, inventory variation records and inventory status records. The database server 110 manages processing of the data stored in the database 100. Such processing includes reading, writing, deleting, modifying, and backup of the data. The application server 120 executes an inventory management program 150, and comprises core and alterable enterprise logic (such as enterprise planning, operation methods and management models) of the system. The application server 120 also processes input of users, and returns results of processing to users. The client computers 130a, 130b, 130c may be general-purpose computer devices such as personal computers, laptops, portable handheld devices (e.g., personal digital assistants—PDAs), or other suitable devices known in the art. Each client computer 130a, 130b, 130c provides a user interface for receiving orders input by the user, and for displaying results of implementation of such orders.

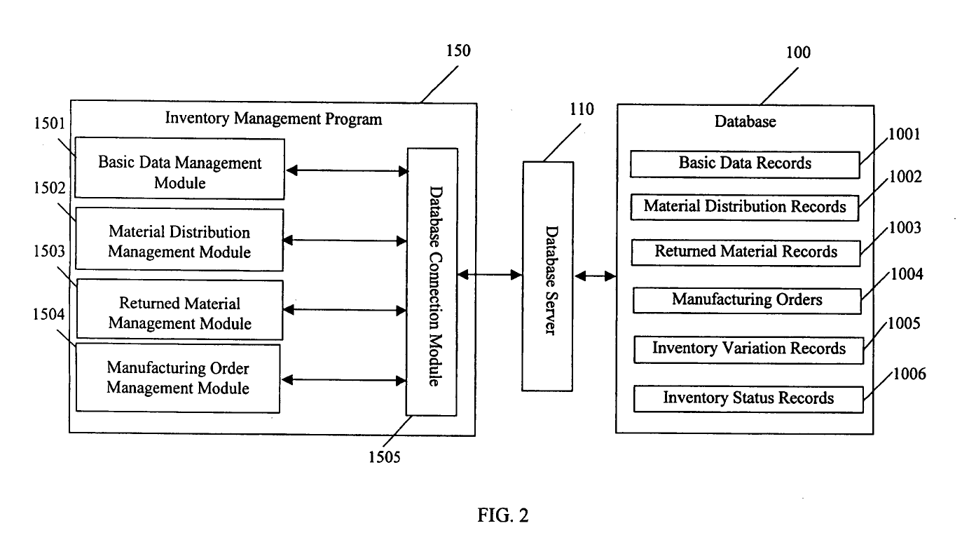

FIG. 2 is a schematic diagram of main software modules of an inventory management program 150 executed by the application server 120, and of main data records stored in the database 100. The inventory management program 150 comprises a basic data management module 1501, a material distribution management module 1502, a returned material management module 1503, a manufacturing order management module 1504, and a database connection module 1505. The database 100 stores information including basic data records 1001, material distribution records 1002, returned material records 1003, manufacturing orders 1004, inventory variation records 1005, and inventory status records 1006.

The basic data management module 1501 maintains information on material types, storage locations, production departments, etc. Such information is stored in the basic data records 1001, and may comprise a plurality of Microsoft Excel (“excel”) sheets. The material distribution management module 1502 manages outgoing stocks that are to be distributed to different places. Such outgoing stocks may comprise materials distributed to production departments, finished goods delivered to customers, and discards. Data on these materials are stored in the material distribution records 1002. The returned material management module 1503 is provided for managing incoming stocks that are received from different places. Such incoming stocks may comprise materials returned from production departments, in-process goods and finished goods that need to be temporarily stocked, and sales returns from customers. Data on these materials are stored in the returned material records 1003. The manufacturing order management module 1504 is used for maintaining manufacturing orders. The manufacturing orders can be preset by users located at the client computers 130a, 130b, 130c, and can also be updated by production management programs automatically. Information on a manufacturing order includes a serial number of the manufacturing order, a status of the manufacturing order, quantities of products used in the manufacturing order, and manufacturing procedures. Such information is stored in the manufacturing orders 1004, and may comprise a plurality of excel sheets.

The database connection module 1505 connects the other software modules of the inventory management program 150 with the database server 110. This enables the basic data management module 1501, the material distribution management module 1502, the returned material management module 1503 and the manufacturing order management module 1540 to access the database 100 conveniently, and obtain and maintain corresponding data records stored in the database 100. For example, the basic data management module 1501 can receive the basic data records 1001 through the database connection module 1505, and perform maintenance operations such as adding, deleting, updating and searching basic data stored in the basic data records 1001.

The inventory variation records 1005 comprise detailed descriptions of inventory variations. When an inventory variation occurs, a corresponding inventory variation record is generated by the inventory management program 150, and stored in the database 100 through the network 140. The inventory status records 1006 comprise current stocks of various materials used in manufacturing orders. The inventory variation records 1005 and the inventory status records 1006 can be accessed and maintained by the basic data management module 1501, the material distribution management module 1502, the returned material management module 1503 and the manufacturing order management module 1504 via the database connection module 1505.

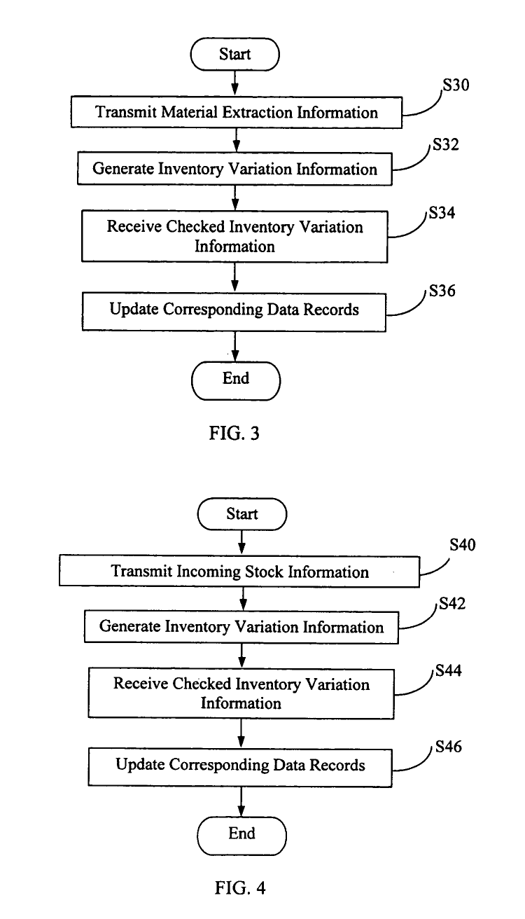

FIG. 3 is a flowchart of the preferred method for managing material distribution in accordance with the present invention. In step S30, a user in a production department logs on one of the client computers 130a, 130b, 130c (e.g. say, 130a), and transmits material extraction information to the application server 120 through the network 140. The material extraction information comprises a production department number, an ID number of a warehouse from which the material is extracted, and a manufacturing order number. In step S32, the material distribution management module 1502 receives the material extraction information, and retrieves the following information from the database 100: a corresponding manufacturing order 1004 according to the manufacturing order number; and a basic data record 1001 according to the production department number and the warehouse ID number. Inventory variation information is then generated by the material distribution management module 1502 according to the basic data record 1001, and according to information on part items and their respective usage quantities specified in the manufacturing order 1004. The inventory variation information is transmitted to the client computer 130a. In step S34, the user in the production department checks the inventory variation information. The checked inventory variation information is returned to the application server 120. In step S36, the material distribution management module 1502 receives the checked inventory variation information, and updates a corresponding material distribution record 1002, a corresponding inventory variation record 1005, and a corresponding inventory status record 1006 according to the checked inventory variation information after the material has been taken out of the warehouse.

FIG. 4 is a flowchart of the preferred method for managing returned materials in accordance with the present invention. In step S40, a user in a production department logs on one of the client computers 130a, 130b, 130c (e.g. say, 130b), and transmits information on incoming stocks that are to be received by a warehouse to the application server 120 through the network 140. Such information includes a production department number, an ID number of the warehouse where the material is received, and a manufacturing order number. In step S42, the returned material management module 1503 receives said information, and obtains from the database 100 a corresponding manufacturing order 1004 according to the manufacturing order number and a basic data record 1001 according to the production department number and the warehouse ID number. Inventory variation information is then generated by the returned material management module 1503 according to the basic data record 1001, and according to information on part items and their respective usage quantities specified in the manufacturing order 1004. The inventory variation information is transmitted to the client computer 130b. In step S44, the user in the production department checks the inventory variation information. The checked inventory variation information is returned to the application server 120. In step S46, the returned material management module 1503 receives the checked inventory variation information, and updates a corresponding returned material record 1003, a corresponding inventory variation record 1005, and a corresponding inventory status record 1006 according to the checked inventory variation information after the material has been received by the warehouse.

Although the present invention has been specifically described on the basis of a preferred embodiment and preferred methods, the invention is not to be construed as being limited thereto. Various changes or modifications may be made to said embodiment and methods without departing from the scope and spirit of the invention.

What is claimed is:

1. A system for managing material distribution and returned materials, the system comprising:
a database for storing relevant data used or generated in implementing the system; and
an application server for managing material distribution and returned materials by executing an inventory management program, the inventory management program comprising a material distribution management module for managing outgoing stocks that are to be distributed to different places, and a returned material management module for managing incoming stocks that are received from different places.

2. The system according to claim 1, further comprising a database server linked to the database, the database server being provided for managing of processing of the data stored in the database.

3. The system according to claim 2, further comprising a plurality of client computers, each of the client computers comprising a user interface for receiving orders input by users, and for displaying results of implementation of said orders.

4. The system according to claim 1, wherein the inventory management program further comprises a basic data management module for maintaining information including material types, storage locations, and production departments.

5. The system according to claim 4, wherein the inventory management program further comprises a manufacturing order management module for maintaining manufacturing orders.

6. The system according to claim 5, wherein the inventory management program further comprises a database connection module, which connects the basic data management module, the material distribution management module, the returned material management module and the manufacturing order management module with the database server, for enabling said modules to access the database conveniently.

7. The system according to claim 1, wherein the relevant data stored in the database comprise basic data records, material distribution records, retuned material records, manufacturing orders, inventory variation records and inventory status records.

8. A method for managing material distribution, comprising:
transmitting material extraction information to an application server;
generating inventory variation information;
receiving checked inventory variation information; and
updating corresponding data records stored in a database, said records comprising a material distribution record, an inventory variation record and an inventory status record.

9. A method for managing returned materials, comprising:
transmitting information on incoming stocks to be received by a warehouse to an application server;
generating inventory variation information;
receiving checked inventory variation information; and
updating corresponding data records stored in a database, said records comprising a returned material record, an inventory variation record and an inventory status record.
